(19) United States
(12) Patent Application Publication
(10) Pub. No.: US 2018/0239786 A1
(43) Pub. Date: Aug. 23, 2018

(54) Augmenting Code For Databases With Modular Code Elements

(71) Applicant: RhinoDox, Chicago, IL (US)

(72) Inventor: Justin Ullman, Glen Ellyn, IL (US)

(21) Appl. No.: 15/902,372

(22) Filed: Feb. 22, 2018

Related U.S. Application Data
(60) Provisional application No. 62/462,213, filed on Feb. 22, 2017.

(51) Int. Cl. G06F 17/30; G06F 8/34; G06F 8/36; G06F 3/0482; G06F 3/06

(52) U.S. Cl. CPC G06F 17/30289; G06F 8/34; G06F 17/30002; G06F 3/0482; G06F 3/0605; G06F 8/36

(57) ABSTRACT

A display device presents a graphical user interface (GUI), wherein the GUI includes one or more configuration options selectable via user input. One or more modular code elements are selected based on the user input. Modified code is generated based on the one or more modular code elements and existing code. The modified code is configured to act on data for a NoSQL database based on the user input.

### CROSS-REFERENCE TO RELATED APPLICATION

This application claims the benefit of U.S. Provisional Application No. 62/462,213, filed Feb. 22, 2017, which is incorporated by reference in its entirety herein.

### TECHNICAL FIELD

This invention relates generally to databases and, more particularly, to NoSQL databases.

### BACKGROUND

Many industries currently use, or have a use for, intricate database structures. The databases can include customer information, product information, healthcare information, etc. Historically, relational database management systems (RDBMS) were used to organize and view data. RDBMS store data in database objects referred to as “tables.” Tables hold a collection of data in rows and columns, similar to a spreadsheet. While RDBMS are useful for storing data, NoSQL document and graph databases offer additional freedom for users. That is, NoSQL databases allows users to configure and store data in formats that are better suited for the users' specific data sets and uses. While NoSQL databases provide users with increased flexibility in the storage of data, a user must also configure the NoSQL database based on the features desired by the user. This configuration typically requires a trained professional, such as a software engineer, to develop additional software code that is used in conjunction with the NoSQL database. Hiring a professional to develop code is not inexpensive and can be cost prohibitive for many users. Consequently, many users are unable to fully utilize the flexibility that a NoSQL database provides.

### BRIEF DESCRIPTION OF THE DRAWINGS

Disclosed herein are embodiments of systems, apparatuses, and methods pertaining to configuration and use of a NoSQL database. This description includes drawings, wherein:

FIG. 1 is a block diagram depicting configuration software 104 operating in conjunction with database software 108 to configure the database software 108 via a user interface 102, according to some embodiments;

FIG. 2 depicts a web browser 200 presenting a user interface with which a user can configure database software, according to some embodiments;

FIG. 3 depicts an example graphical user interface (GUI) 300, according to some embodiments; and

FIG. 4 is a flow diagram depicting example operations for configuring database software via a user interface, according to some embodiments.

Elements in the figures are illustrated for simplicity and clarity and have not necessarily been drawn to scale. For example, the dimensions and/or relative positioning of some of the elements in the figures may be exaggerated relative to other elements to help to improve understanding of various embodiments of the present invention. Also, common but well-understood elements that are useful or necessary in a commercially feasible embodiment are often not depicted in order to facilitate a less obstructed view of these various embodiments of the present invention. Certain actions and/or steps may be described or depicted in a particular order of occurrence while those skilled in the art will understand that such specificity with respect to sequence is not actually required. The terms and expressions used herein have the ordinary technical meaning as is accorded to such terms and expressions by persons skilled in the technical field as set forth above except where different specific meanings have otherwise been set forth herein.

### DETAILED DESCRIPTION

Generally speaking, pursuant to various embodiments, systems, apparatuses, and methods are provided herein useful to configuration and/or use of a NoSQL database. In some embodiments, one or more computer-readable storage media, having instructions stored therein, which when executed by one or more processors cause the one or more processers to perform operations including presenting, via a display device, a graphical user interface (GUI), wherein the GUI includes one or more configuration options selectable via user input for application to a NoSQL database and selecting, based on the user input, one or more modular code elements. Based on the one or more modular code elements and existing code, modified code is generated, wherein the modified code is configured to work with the NoSQL database to one or any combination of add, modify, apply security features to, apply semantic enrichment to, or allow batch ingestion of data for the NoSQL database based on the user input.

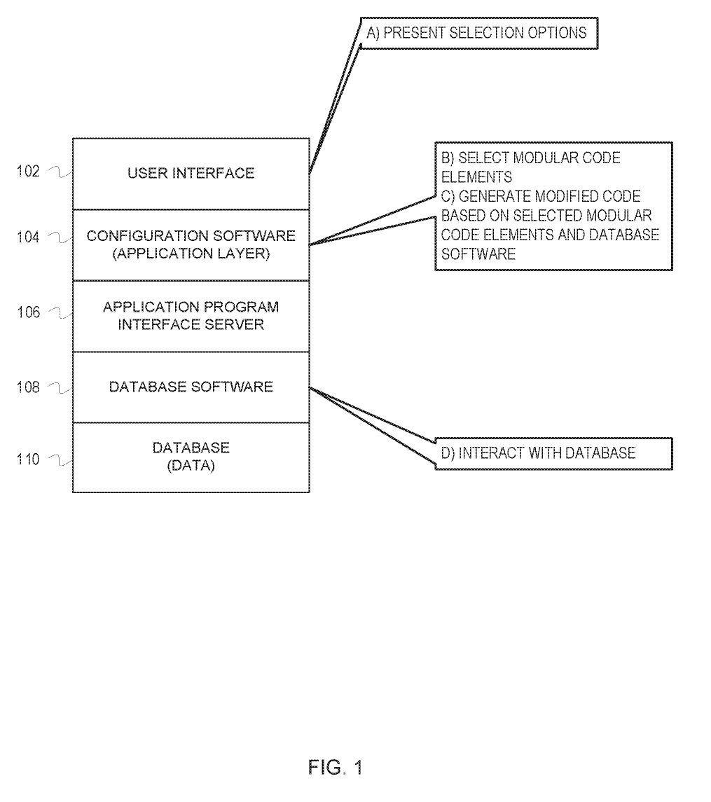

As previously discussed, NoSQL databases generally offer a user greater flexibility than RDBMS. For example, NoSQL databases do not require that all data conform to a predefined schema, such as a table as required by RDBMS. Accordingly, NoSQL databases allow users to develop data storage formats and allow data to be stored in multiple different formats as suited for the user's use of the data. While NoSQL databases are a powerful tool, oftentimes users must purchase database software (i.e., software for the NoSQL database) and then hire a professional, such as a software developer, to develop code that allows the user to interact with and use data in the NoSQL database. Hiring a professional to configure the database software can be both expensive and time consuming such that use of NoSQL databases is cost prohibitive for many users. Systems, methods, and apparatuses described herein seek to eliminate or reduce the cost and complexity of configuring a NoSQL database. In some embodiments, configuration software provides a user interface. A user can interact with the user interface to configure the database software via the configuration software. The configuration software, via the user interface, uses the modular code that is pre-configured to work together and within the context of a NoSQL database, such as the kind made by MarkLogic, to allow a user to configure the NoSQL database without the need to hire a professional. The particular combination of modular code allows ready use of a NoSQL database which reduces need for specialized and professional consultation and unique professional code writing. The discussion of FIG. 1 provides background information about such configuration software.

FIG. 1 is a block diagram depicting configuration software 104 operating in conjunction with database software 108 to configure the database software 108 via a user interface 102, according to some embodiments. The block diagram includes a database 110, database software 108, an application program interface (API) server 106, configuration software 104, and a user interface 102. In some embodiments, the NoSQL database, as purchased by a user, includes the database 110, the database software 108, and the API server 106. The configuration software 104, running in the application layer, provides the user interface 102. Additionally, in some embodiments, the configuration software 104 may include additional APIs which are installed on the API server 106 by the configuration software 104. The user interface 102 allows the user to configure the database software 108. Configuration of the database software 108 provides usability of the database 110 to the user. For example, the configuration software 104 allows the user to perform cabinet configuration as well as dictate the manner in which users can interact with the database 110. FIG. 1 depicts operations at stages A-D. The stages are examples and are not necessarily discrete occurrences over time (e.g., the operations of different stages may overlap). Additionally, FIG. 1 is an overview of example operations.

At Stage A, the user interface 102 presents selection options. The configuration software 104 generates the user interface 102 and causes the user interface 102 to be presented. The user interface 102 can be presented via a display device, such as a computer monitor, a smartphone, a tablet computer, etc. The selection options provide the user with options for configuring the database software 108 as well as providing the functionality to the database 110. For example, the options may allow the user to select what data fields will be used, select a format in which the data will be stored, select a manner in which the data will be searched, select associations between different data fields and elements, select security settings, perform cabinet configuration, etc.

At Stage B, the configuration software 104 selects modular code elements based on the user input. In some embodiments, the configuration software 104 selects the modular code elements by selecting “labels.” The labels correspond to API calls from the API server 106. In such embodiments, the “labels” can be referred to as modular code elements, as the “labels” correspond to API calls (i.e., modular code elements). Put simply, the user interface 102 provides selection options for a user which correspond to API calls. The modular code elements are segments of software code that are used to configure the database software 108 and provide functionality to the database 110. For example, one or more of the modular code elements defines how data will be stored in the database 110. As another example, one or more of the modular code elements dictate how the data will be searched (e.g., which fields, if the data includes documents which portion of the documents, etc.). Other modular code elements that can be applied to the NoSQL database environment include modules relating to providing a configurable data model for data to be stored in the database, providing a configurable granular security model for the data to be stored in the database, using a batch ingestion engine for loading batches of data into the NoSQL database, incorporating semantic enrichment into user interaction with the NoSQL database, providing a custom versioning model for the NoSQL, and any combination of these options.

At Stage C, the configuration software 104 generates modified code. The modified code is based on the selected modular code elements and existing code (i.e., existing code for the database software 108). That is, the configuration software 104 augments the database software 108 with the selected modular code elements to generate the modified code. In some embodiments, the generation of the modified code reduces or eliminates the need for a professional to configure the database software 108. In embodiments in which the configuration software 104 selects “labels” (which correspond to API calls), the configuration software generates the modified code by selecting API calls in the API server 106 that configure the database software 108 and provide functionality to the database 110. Accordingly, the configuration software 104 augments the database software 108 by selecting the API calls.

At Stage D, the modified code (i.e., the existing code as augmented with the selected modular code elements) is used to interact with the database 110. The modified code can be used to interact with the database 110 by modifying the data stored in the database 110, searching the data in the database 110, imposing security restrictions on the data in the database 110, and the like.

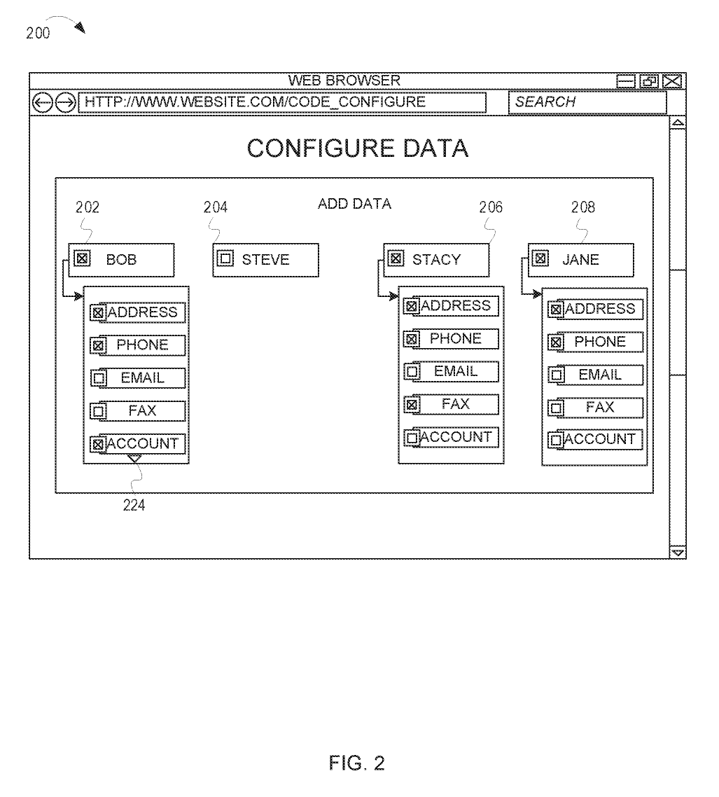

While the discussion of FIG. 1 provides an overview of configuration software for configuring database software, the discussion of FIG. 2 describes a user interface used to configure the database software.

FIG. 2 depicts a web browser 200 presenting a user interface with which a user can configure database software, according to some embodiments. The user interface can be a graphical user interface (GUI), such as that depicted in FIG. 2. Although the user interface depicted in FIG. 2 allows for configuration of data elements related to people, such as customers, other user interfaces exist. For example, user interfaces may allow a user to configure security features for data, search features and mechanisms (e.g., semantic enrichment) for data, a schema or format in which data will be stored, and any other of the configurable code modules discussed above. The user interface depicted in FIG. 2 includes selection elements for four people: a first selection element 202 for Bob, a second selection element 204 for Steve, a third selection element 206 for Stacy, and a fourth selection element 208 for Jane. When a selection element is selected, the user interface presents a menu, such as first menu 224. The first menu 224 includes additional submenus for information associated with the person. Specifically, the first menu 224 includes submenus for an address, a phone number, an email address, a fax number, and an account number for Bob. The user can configure the database by inputting data in the menus and submenus.

As previously discussed, the user interface may also allow the user to configure the database software in additional ways. For example, the user interface may allow the user to configure data models as represented in the user interface by cabinet, folder, document set/type, group security, create groups, access based on user, semantic enrichment, required attribute and data types, etc.

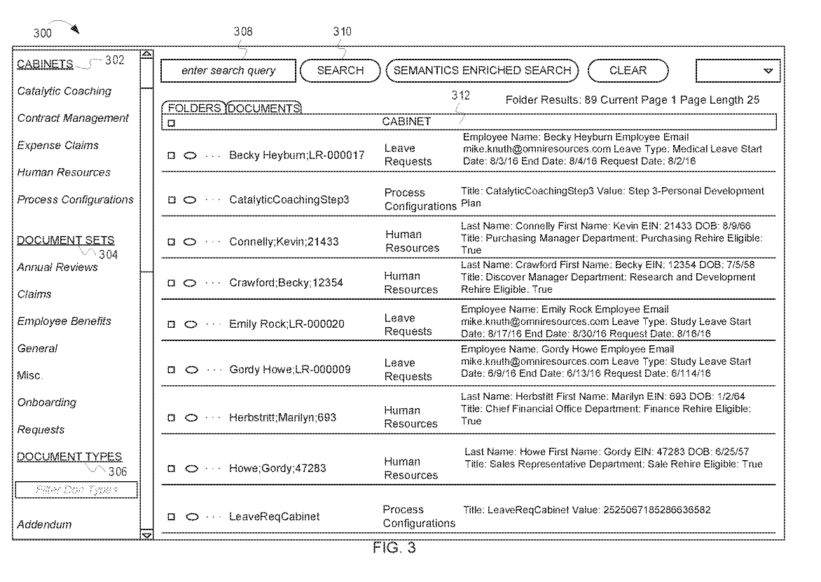

Like the discussion of FIG. 2 provides additional information regarding a user interface used to configure database software, the discussion of FIG. 3 provides additional information regarding another example user interface.

FIG. 3 depicts an example GUI 300, according to some embodiments. Although the GUI 300 depicted in FIG. 3 is presented via a web browser, such a configuration is not required. For example, in some embodiments, the GUI 300 can be presented via a thick client application. The GUI 300 includes multiple filter options, such as a cabinet filter 302, a document set(s) filter 304, and a document type(s) filter 306. A user can select one or more of these filters, or options within the filters, to view specific data. For example, using the cabinet filter 302, the user can view the catalytic coaching cabinet.

The GUI 300 also includes a search query field 308. The user can enter a search query into the search query field 308 to initiate a search of the database based on the search query. Further, the GUI 300 includes a semantic enrichment feature 310. Selection of the semantic enrichment feature 310 allows the user to perform a search using semantic enrichment. The GUI 300 presents results of the user's search in a results window 312. The results can be sorted and filtered within the search results window 312. The user can sort or filter the results by cabinet, document, etc.

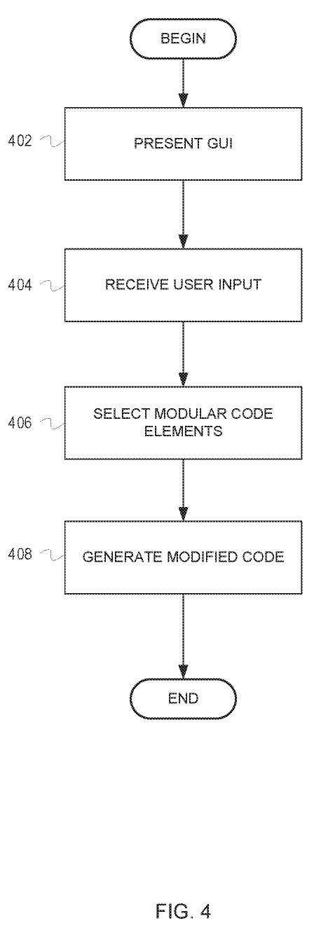

While the discussion of FIGS. 2 and 3 provide additional detail regarding example user interfaces, the discussion of FIG. 4 describes example operations for configuring database software.

FIG. 4 is a flow diagram depicting example operations for configuring database software via a user interface, according to some embodiments. The flow begins at block 402.

At block 402, a user interface is presented. For example, configuration software can present a user interface such as a GUI. The configuration software presents the user interface via a display device. The user interface allows a user to configure database software. Specifically, the user interface allows the user to modify the database software so that the user can interact with the database as desired. For example, the user can configure how data is entered and/or stored in the database, how data is searched in the database, security features for the data in the database, associations between data in the database, semantic enrichment features, API access, and the like including any combination thereof. The flow continues at block 404.

At block 404, user input is received. For example, the user interface can receive the user input. The user input defines the user's selections to configure the database. The user interface can receive the user input via one or more of menus, radio buttons, textual input, auditory input, and the like. The flow continues at block 406.

At block 406, modular code elements are selected. For example, the configuration software selects modular code elements based on the user input. As one example, if the user input selects a schema for the database, the configuration software can select modular code elements that will configure the database software to store the data in a manner consistent with the schema. The configuration software selects the modular code elements from a number of modular code elements. In some embodiments, the modular code elements are API calls that correspond to “labels.” In such embodiments, selection of modular code elements comprises selection of the “labels.” The flow continues at block 408.

At block 408, the modified code is generated. For example, the configuration generates the modified code based on the selected modular code elements and existing code for the database software. In one embodiments, the configuration software generates the modified code by augmenting the existing code with the selected modular code elements. As one example, the configuration software can insert the selected modular code elements into the existing code.

Those skilled in the art will recognize that a wide variety of other modifications, alterations, and combinations can also be made with respect to the above described embodiments without departing from the scope of the invention, and that such modifications, alterations, and combinations are to be viewed as being within the ambit of the inventive concept.

As will be appreciated by one skilled in the art, aspects of the inventive subject matter may be embodied as a system, method or computer program product. Accordingly, aspects of the inventive subject matter may take the form of an entirely hardware embodiment, an entirely software embodiment (including firmware, resident software, micro-code, etc.) or an embodiment combining software and hardware aspects that may all generally be referred to herein as a “circuit,” “module,” or “system.” Furthermore, aspects of the inventive subject matter may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the inventive subject matter may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the inventive subject matter are described with reference to flowchart illustrations and/or block diagrams of methods, apparatus (systems) and computer program products according to embodiments of the inventive subject matter. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

Generally speaking, pursuant to various embodiments, systems, apparatuses and methods are provided herein useful to configuration of a NoSQL database. In some embodiments, one or more computer-readable storage media, having instructions stored therein, which when executed by one or more processors cause the one or more processers to perform operations comprising presenting, via a display device, a graphical user interface (GUI), wherein the GUI includes one or more configuration options selectable via user input, selecting, based on the user input, one or more modular code elements, and generating, based on the one or more modular code elements and existing code, modified code, wherein the modified code is configured to act on data based on the user input.

In some embodiments, an apparatus and a corresponding method performed by the apparatus comprises presenting, via a display device, a graphical user interface (GUI), wherein the GUI includes one or more configuration options selectable via user input, receiving, via the GUI, user input, selecting, based on the user input, the one or more modular code elements, and generating, based on the one or more modular code elements and an existing code, modified code, wherein the modified code is configured to act on data based on the user input.

What is claimed is:

1. One or more computer-readable storage media, having instructions stored therein, which when executed by one or more processers cause the one or more processors to perform operations comprising:
presenting, via a display device, a graphical user interface (GUI), wherein the GUI includes one or more configuration options for application to a NoSQL database;
receiving, via a user input device, user input, wherein the user input selects at least one of the one or more configuration options for application to the NoSQL database;
selecting, based on the user input, one or more modular code elements, wherein the modular code elements are associated with the at least one of the one or more configuration options for application to the NoSQL database; and
generating, based on the one or more modular code elements and existing code, modified code, wherein the existing code is associated with database software for the NoSQL database, wherein the modified code is configured to work with the NoSQL database to one or any combination of add, modify, apply security features to, apply semantic enrichment to, or allow batch ingestion of data for the NoSQL database based on the user input.

2. The one or more computer-readable storage media of claim 1, wherein the generating the modified code comprises augmenting the existing code with the one or more modular code elements.

3. The one or more computer-readable storage media of claim 2, wherein the one or more modular code elements augment the existing code based on a schema.

4. The one or more computer-readable storage media of claim 1, wherein the existing code includes database software and the one or more modular code elements define search features of a database with which the database software is associated.

5. The one or more computer-readable storage media of claim 1, wherein the user input defines a schema.

6. The one or more computer-readable storage media of claim 1, wherein the user interface includes one or more menus.

7. The one or more computer-readable storage media of claim 1, wherein the GUI allows for selection of one or more data fields.

8. The one or more computer-readable storage media of claim 1, wherein the one or more modular code elements impose security restrictions on the data.

9. The one or more computer-readable storage media of claim 1, wherein the one or more modular code elements provide for semantic enrichment.

10. A method for generating modified code with one or more modular code elements, the method comprising:
presenting, via a display device, a graphical user interface (GUI), wherein the GUI includes one or more configuration options for application to a NoSQL database;
receiving, via a user input device, user input, wherein the user input selects at least one of the one or more configuration options for application to the NoSQL database;
selecting, based on the user input, one or more modular code elements, wherein the one or more modular code elements are associated with the at least one of the one or more configuration options for application to the NoSQL database; and
generating, based on the one or more modular code elements and an existing code, the modified code, wherein the existing code is associated with database software for the NoSQL database, wherein the modified code is configured to work with the NoSQL database to one or any combination of add, modify, apply security features to, apply semantic enrichment to, or allow batch ingestion of data for the NoSQL database based on the user input.

11. The method of claim 10, wherein the generating the modified code comprises augmenting the existing code with the one or more modular code elements.

12. The method of claim 11, wherein he one or more modular code elements augment the existing code based on a schema.

13. The method of claim 10, wherein the existing code includes database software and the one or more modular code elements define search features of a database with which the database software is associated.

14. The method of claim 10, wherein the user input defines a schema.

15. The method of claim 10, wherein the user interface includes one or more menus.

16. The method of claim 10, wherein the GUI allows for selection of one or more data fields.

17. The method of claim 10, wherein the one or more modular code elements impose security restrictions on the data.

18. The method of claim 10, wherein the one or more modular code elements impose provide for semantic enrichment.
